(19) United States
(12) Patent Application Publication
(10) Pub. No.: US 2024/0208414 A1
(43) Pub. Date: Jun. 27, 2024

(54) Systems and Methods to Provide Otherwise Obscured Information to a User

(71) Applicant: Rovi Guides, Inc., San Jose, CA (US)

(72) Inventors: Anjum Makkar, Abohar (IN); Vishwas Sharadanagar Panchaksharaiah, Karnataka (IN); Harshith Kumar Gejjegondanahally Sreekanth, Shivamogga (IN); Pawan Nagdeve, Bangalore (IN); Cato Yang, San Jose, CA (US)

(21) Appl. No.: 18/088,220

(22) Filed: Dec. 23, 2022

(51) Int. Cl. B60R 1/23; B60R 1/28

(52) U.S. Cl. CPC B60R 1/23; B60R 1/28; B60R 2001/1215

(57) ABSTRACT

Systems and methods are presented for enhancing media or information consumption. An example method includes identifying a movement of a first user, identifying an object referenced by the movement of the first user external to the first user, and in response to determining that the object is at least partially obstructed from a field of view of a second user, generating, for display on a display that is within the field of view of the second user, a view of the object.

### BACKGROUND

The present disclosure relates to enhancing media or information consumption, including in mixed reality experiences, such as by identifying and presenting to a user information about objects external to the user and that may be obscured from the user.

### SUMMARY

While traveling in a vehicle, occupants may miss out on viewing objects external to the vehicle that are of particular interest to them, such as buildings, businesses, animals, plants, historical objects, popular objects, static objects, dynamic objects, or the like. For example, the user may be interested in viewing a historical building and/or related information, but the user may be unable to view the interesting portion because the building is obscured by intermediate objects or other passengers, is unknown to the user, or is too distant when the user becomes aware of its existence or their interest in it. In many cases a first occupant will see and point out an interesting object, but other occupants are either blocked from viewing the object by the vehicle or other passengers or cannot identify what the first occupant is referring to. The vehicle may also be moving, resulting in a limited time window for the occupants to identify and view the object.

In another example, a user may be operating in an augmented reality (AR) or virtual reality (VR) environment, such as in a video game or vehicle simulator. While the user may not physically move with respect to one or more objects, the environment may still be such that one or more objects or interesting features are obscured. The user may wish to view or learn more about certain objects within the environment (either in the real world or in an AR/VR environment).

To help address these and other issues, systems, methods, and applications are provided to enhance media and information consumption of users by identifying objects external to the vehicle (or obscured by other objects within an AR/VR environment) that may be of interest to the user. While embodiments of this disclosure are described with respect to a physical environment (e.g., a user or users traveling within a vehicle and objects external to the vehicle), it should be appreciated that the same concepts, features, and functions described below may also apply to a user or users operating within an AR/VR environment.

In a first example, a first user may identify an object, and attempt to show the object to a second user. In response to determining that the view of the second user is obstructed, the object may be displayed on a display inside the vehicle for the second user to view. This enables the second user to quickly identify the object, and to have an unobstructed view of the object in real-time or near-real time as the first user points out the object. All users of the car are then able to see the object identified by the first user. In some embodiments, the external object may be identified based on a movement of the first user, such as via movement of the first user's head, arm, or hand toward the object. In addition, the first user may use speech (e.g., “look at that building”), which may be used along with or instead of the movement to identify the external object.

In some embodiments, the external object may be identified by using a field of view, gaze, or eye direction of the first user. This can include identifying one or more objects outside the vehicle that are within a field of view of the first user and selecting one of the objects in that field of view based on additional information (e.g., speech of the first user, a direction the first user is pointing, a ranking of likely objects within the field of view, etc.).

In some embodiments, determining that the object is at least partially obstructed from the second user's field of view includes making the determination based on the position of the second user, the direction in which the second user is looking (i.e., the second user's field of view), and known information about the structural elements of the vehicle which may obstruct the second user's view. Furthermore, the second user may make an audible indication that the object is obstructed (e.g., “I can't see it”).

In some embodiments, the unobstructed view of the object may be displayed to the second user by displaying the unobstructed view on a window of the second user, or on a different window that is positioned between the second user and the object itself.

In a second example, a user may wish to learn more information about an object external to the vehicle. In another approach, when a user identifies an object external to the vehicle for which he or she would like more information, the user may be required to reach his or her destination, remember back to the object, and look up additional information at that point. Or alternatively, the user may perform a search to identify the object, and the perform further searching to retrieve relevant additional information. Furthermore, where the user interested in the object is the driver of the vehicle, the driver may need an additional user to perform the searching and information retrieval. This may not even be possible where the driver is alone in the vehicle.

With these issues in mind, systems, methods, and applications are provided to enhance travel experiences of users by automatically identifying objects external to the vehicle that may be of interest to the user, searching for and retrieving relevant additional information pertaining to the objects, comparing the additional information to a user profile of the interested user(s), and automatically displaying the relevant additional information to the user(s). This enables automatic identification and display of relevant information, faster display of information such that the information is available while the object is still in view, reduced opportunity for errors in object identification and searching by removing the need for manual identification and search, reduced confusion about which object the users are interested in, and can be done for a single user without requiring an additional person to perform object identification and searching for additional relevant information. Furthermore, embodiments of the present disclosure enable the display of only the most relevant information pertaining to a particular user's interests, and avoids displaying extraneous or irrelevant information that a given user is not interested in. This enables each user to be presented with different information pertaining to each user's particular interests, thereby improving the overall user experience.

In some embodiments, the object external to the vehicle may be identified based on a voice signal from the user (e.g., “look at that building”). Alternatively, the object may be identified based on a passive action of the user, such as a gesture with the user's hand or head in the direction of the object. A combination of gestures, movements, and/or voice signals can also be used.

In some embodiments, movement and positioning of the user over time may be analyzed to identify the object. For instance, as the vehicle travels down a road, the user may lock his or her eyes onto an object on the side of the road. The gaze or eye direction of the user may be tracked over time, and the object may be identified based on the object's presence within the field of view of the user over time.

In some embodiments, a second user may be present in the vehicle, and may have different interests from the first user. Certain embodiments may include (a) displaying to the first user a first set of information relevant to the object and the first user's interests, and (b) displaying to the second user a second set of information relevant to the object and the second user's interests.

In a third example, a driver or occupant of a vehicle may have an interest in an object external to a vehicle, but the object may be partially or fully obscured from view. In another approach, the user may be unaware that he or she is passing by the object because it is obscured from view. Or the user may only be able to partially view the object for a short time as the object passes by.

With these issues in mind, systems, methods, and applications are provided to enhance travel experiences of users by automatically identifying objects external to the vehicle that are relevant to the interests of the user(s) of the vehicle. This includes automatically identifying an object external to the vehicle, determining that the object is relevant to the interests of one or more occupants of the vehicle, determining that the interested occupants' view of the object is obstructed, and displaying an unobscured view of the object to the interested occupant within the vehicle. This enables the interested occupant to be made aware of the external object which she otherwise may not have seen, and to also see an unobstructed view of the object itself and/or relevant additional information pertaining to the object.

In some embodiments, the unobstructed view of the object may be a view of the object from the same angle as what the user would see naturally by looking from the vehicle.

In some embodiments, a second user in the vehicle may also have an obstructed view, and the unobstructed view of the object may also be displayed on a second display for the second user to see.

In some embodiments, the object external to the vehicle may be identified based on user profile information or interests of the user. In other embodiments, the object may be identified based on a voice signal from the user (e.g., “look at that building”), or based on a passive action of the user such as a gesture with the user's hand or head in the direction of the object. A combination of gestures, movements, and/or voice signals can also be used.

In some examples, the interested occupant may be a user who is prevented from viewing the object due to the presence of another user in the vehicle blocking the view.

Notably, the present disclosure is not limited to the combination of the elements as listed herein and is assembled in any combination of the elements as described herein. These and other capabilities of the disclosed subject matter will be more fully understood after a review of the following figures, detailed description, and claims.

### BRIEF DESCRIPTION OF THE DRAWINGS

The above-mentioned and further advantages of the disclosure will be apparent upon consideration of the following detailed description, taken in conjunction with the accompanying drawings, in which like reference characters refer to like parts throughout, and in which:

FIG. 1 depicts an example scenario for identifying and displaying obscured objects to a user in a vehicle, according to aspects of the present disclosure;

FIG. 2 depicts a second example scenario for identifying and displaying objects and related information to a user in a vehicle, according to aspects of the present disclosure;

FIG. 3 depicts a third example scenario for identifying and displaying objects and/or information to a user in a vehicle, according to aspects of the present disclosure;

FIGS. 4A-4C depict a series of views showing the changing field of view of a user of a vehicle as the vehicle travels near an object;

FIG. 5 depicts a fourth example scenario for identifying and displaying objects and related information to a user in a vehicle, according to aspects of the present disclosure;

FIG. 6 depicts a block diagram of an illustrative example of a user equipment device, according to aspects of the present disclosure;

FIG. 7 depicts an illustrative system implementing the user equipment device, according to aspects of the present disclosure;

FIG. 8 depicts a flowchart of a process for identifying and displaying objects and information to users of a vehicle, according to aspects of the present disclosure;

FIG. 9 depicts a flowchart of a process for identifying and displaying metadata for objects to a user of a vehicle, according to aspects of the present disclosure; and

FIG. 10 depicts a flowchart of a process for identifying and displaying obscured objects to a user of a vehicle, according to aspects of the present disclosure.

### DETAILED DESCRIPTION

The present disclosure is related to the identification and display of information and images relevant to users of a vehicle, or users of an AR/VR system. As noted above, in the world of travelling, one common problem faced by users of a vehicle during travel is missing out on a view of a particular object that the user is interested in but could not properly see. Another common problem involves a first user wanting to show an interesting object (like a shop, factory, animal, static object etc.) to a second user, but by the time the second user finds the object to look at it, the opportunity to view the object has already passed due to factors like the vehicle speed, obstructing objects, traffic, incorrect viewing angle, and sitting position. In other cases, a user may catch a glimpse of an object and get an urge to know more about the object.

Various embodiments of the present disclosure may include one or more augmented reality (AR) devices. These devices may be positioned inside the vehicle, to display images and information to occupants of the vehicle as discussed below. These AR devices may include cameras, projectors, microphones, speakers, communication interfaces, and/or any other suitable sensors or components as described below. In some examples, the AR devices may be communicatively coupled to the vehicle itself, which may enable the AR devices to make use of information gathered via the vehicle sensors, cameras, and more, store images and data, share memory or storage, or otherwise operate alongside or integrated with the electronic systems and devices of the vehicle.

As noted above, the AR devices may be positioned in any suitable place inside or outside the vehicle. For example, in one configuration a first AR device is positioned on the ceiling of the vehicle between the front seats, configured to record all the angles from the sides and front of the vehicle, and to project images and information onto the windshield and front side windows of the vehicle. A second AR device is positioned on the ceiling of the vehicle in the center of the back seats, configured to record all the angles from the sides and back of the vehicle, and to project images and information on the back side windows and rear windshield of the vehicle.

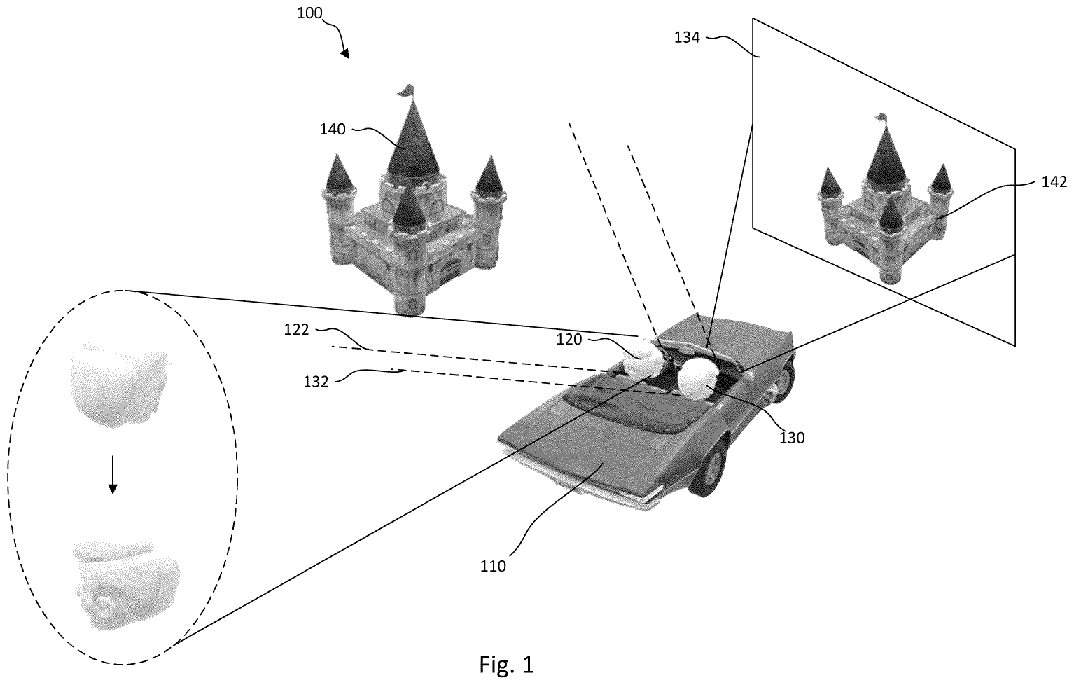

FIGS. 1-5 depict a vehicle configured to communicate with or implement at least a portion of a vehicle content interface application (referred to herein as the “VCI application”). Although the vehicles are depicted as including certain components and devices, the vehicles may include any or all of the components or devices, and/or may execute any or all functions depicted in other drawings. For example, the vehicle 110 in FIG. 1 may include vehicle control circuitry, which enables the VCI application to function as described herein.

FIG. 1 illustrates a scenario 100, wherein a VCI application is configured to identify and display information interesting to a user 120 traveling in a vehicle 110, the information pertaining to an object 140 external to the vehicle 110. The VCI application may be configured to operate within one or more AR devices, may be configured to operate as a part of the vehicle systems, may be configured to operate as a standalone device or system, and/or may be configured to operate on a combination of devices or systems such as a combination of one or more servers and user devices.

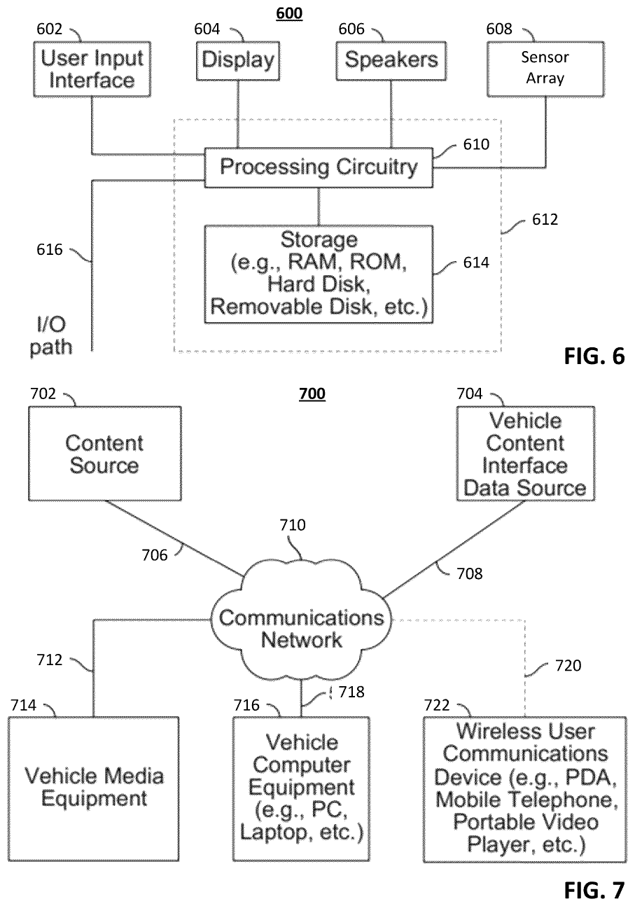

In the embodiment illustrated in FIG. 1, the VCI application is configured to identify a movement of the first user 120 of the vehicle 110. The movement of the user 120 may be identified using one or more vehicle sensors (e.g., cameras, pressure sensors, light sensors, ultrasonic sensors, etc.). For example, the AR devices within the vehicle may include cameras and processing capability to detect the head orientation of the user 120 over time, and to identify via image analysis when the user 120's head changes orientation beyond a threshold amount. These vehicle sensors may be included in the sensor array 608 described below with reference to FIG. 6.

As shown in the example of FIG. 1, the first user 120 movement can include a head movement. FIG. 1 illustrates an example head movement wherein the user 120's head is in a first forward facing orientation, and moves to a second, side facing orientation. In other examples, the movement can include movement of the user 120's arm, hand, fingers, a change in body orientation, occupant position in the vehicle, and/or a change in the field of view of the user 120 (e.g., using gaze detection). In some examples, the VCI application may use DTS AutoSense™ technology to detect which direction the user is looking in, and how that direction changes over time.

The VCI application is also configured to identify an object external to the vehicle (e.g., object 140 as shown in FIG. 1), and in particular to identify the object that corresponds to, is referenced by, or is otherwise related to the movement of the first user 120. In some examples, the movement of the user 120 (i.e., turning his head to look outside the side of the vehicle) is a triggering event that kicks off the process of identifying an object, and in particular triggering the process of identifying the object that caused the user 120's head to turn.

The VCI application may identify the object 140 based on (a) movement of the user 120, (b) a voice signal received from the user 120, and/or (c) a combination of movement and voice signal. The VCI application may capture 360-degree external views from the vehicle, receive movement, voice, or other information as noted below, and correlate the movement voice or other information with the captured views to identify the external object.

As illustrated in FIG. 1, the object 140 is identified based on the object 140 being included in the field of view 122 of the user 120, after the user 120 moves his head from a forward-facing orientation to a side-facing orientation. In some examples, the field of view of the user extends 120 degrees centered on the eye direction of the user (e.g., the eye direction +/−60 degrees horizontally to either side). The field of view may be different for different users, different based on the time of day or environmental conditions, may be determined based on prior history of a user and previously determined field of view, may be based on user profile information (e.g., whether the user wears glasses or contacts), or may be manually entered by a user. In FIG. 1, the field of view 122 extends sideways from the vehicle. The VCI application may detect the ending head orientation and/or eye gaze direction of the user 120 as the head movement ends and correlate the head orientation with the field of view 122. The VCI application may then perform image analysis on images captured by the vehicle that include the same view as the field of view 122, in order to identify potential objects that could be of interest. In the example of FIG. 1, the VCI application may identify the object 140 as the most likely object that the user 120 is looking at, based on how much it stands out from the rest of the image (i.e., there are no other more important objects in the field of view).

In some examples, the object 140 may be identified based on movement of the user 120's hand, arm, fingers, or other movements described herein. Similar to the description above, the VCI application may detect the position and orientation of the user 120's hand, arm, or fingers, and use that information to identify the direction the user is referring to. The VCI application may then compare images including the identified direction, in order to determine the most likely object external to the vehicle to which the user 120 is pointing or referring.

In some examples, the object 140 may be identified based on a voice input received from the user 120. For example, the user 120 may say “look at that castle,” “wow, did you see that?,” or any other voice signal which may help the VCI application to identify the object 140. The VCI application may perform natural language processing or speech analysis on the voice signal to determine the content of the voice signal. The content can then be analyzed to determine whether and to which object the user 120 is referring. Additionally, speech analysis and/or natural language processing can be used in combination with image processing to determine whether the received voice signal refers to any object that is in the images captured by the vehicle cameras.

In some examples, the VCI application may use both movement and voice signals from the user 120 to identify the object 140. For example, the user 120 may point at the object 140 and say, “look at that castle.” The VCI application could use both the movement data and the voice data to increase a confidence level associated with the identification of the object 140.

In some examples, the surroundings of the vehicle 110 include multiple potential objects that the VCI application may identify. For example, when traveling down a street, there are typically multiple stores or buildings next to each other. If the user 120 says “look at that building,” it is unclear based solely on the voice signal to which building the user 120 is referring. In this case, the VCI application may determine a field of view of first user 120 and identify multiple potential objects that are included in the field of view. Similarly, where the user gestures with his hand, fingers, arm, or other movement, the VCI application may determine multiple objects that are potentially being referenced by the detected movement of the first user 120.

The VCI application may then select one of the multiple potential objects based on various factors, including (a) voice input from the first user 120, (b) voice input from the second user 130, (c) movement of the first user 120, (d) movement of the second user 130, (e) a combination of movements and/or voice input from the first and second users 120 and 130, or (f) a predetermined hierarchy of objects.

The VCI application may use voice input from the first user to select or narrow down the possible object from the plurality of possible objects. For example, the first user 120 may say “look at that castle.” Where the possible objects within the field of view of the first user 120 include a castle, a billboard, and various trees or other natural objects, the voice input referring to the castle may be used to identify the castle 140 as the target object. Similarly, the second user 130 may say “did you mean that castle right there?,” or “do you mean the brown building?,” which may also be used to differentiate between and identify a target object from the potential objects.

The VCI application may also use movement of the first user or second user to identify the object from the plurality of possible objects. For example, the first user may point toward the object 140, and continue to point at the object 140 as the vehicle 110 moves. The direction of the user's finger may track the object 140, and therefore differentiate the object 140 from other possible objects. Similarly, the second user 130 may make a movement to look at or point at the object 140, thereby differentiating the object 140 from other possible objects. In some examples, the gaze direction of the first user 120 and second user 130 may be compared, to determine which objects are included in both or are in the general direction of the gaze of both users. The first and second user's gazes may be tracked over time to determine which object is common to both.

Furthermore, a combination of both movement and/or voice signals from one or both users 120 and 130 may be used to identify the object 140.

In some examples, the VCI application may use a predetermined hierarchy of objects to identify the likely object to which the user 120 is referring. For example, if there are multiple objects nearby each other, such as a castle, billboard, old building, and a convenience store (all within the same field of view when looking from the vehicle 110), the VCI application may rank the objects (or may access a ranking of objects) to make an assumption about which object the user 120 is likely referring to. The VCI application may have a default ranking or may use a ranking determined based on a user profile for the user 120, wherein the user's interests (e.g., the user 120 is interested in architecture) to determine that the castle is the most likely object being referenced by first user 120.

After identifying the object, the VCI application may determine that the object is at least partially obstructed from a field of view of the second user 130. To determine that the object 140 is at least partially obstructed, the VCI application may use a combination of factors. In one example, the VCI application may determine a second field of view 132 of the second user 130. The second field of view 132 may be determined in a similar manner to the first field of view 122, using cameras, gaze tracking, eye tracking, or the use of other sensors (e.g., sensor array 608 described below). The VCI application may also use the known locations of vehicle structures, positioning of the second user 130 within the vehicle (e.g., whether the second user 130 is on the same side or opposite side as the object 140), the position of the object 140 relative to the vehicle, and/or the presence of other objects outside the vehicle which may obscure the second user's view of the object 140.

Based on the determined second user field of view 132, and/or the positioning of the second user 130 and object 140 relative to each other and the other occupants, vehicle structures, and other objects, the VCI application may determine that the second user's view of the object 140 is at least partially obstructed.

In some examples, the VCI application may determine that the second user 130's view is obstructed based on a verbal signal received from the second user 130. For instance, the second user 130 may say “I can't see it.” Additionally, the VCI application may use movement of the second user to determine that he is obstructed (e.g., where the second user keeps moving his head to attempt to see the object 140, or scans back and forth without locking onto the object 140).

In one example, the VCI application may determine that the second user 130 is at least partially obstructed from viewing the object 140 based on a combination of factors. The combination of factors may include (a) a position of the second user inside the vehicle, and thereby whether other passengers or vehicle structures are positioned between the second user and the object, (b) a field of view of the second user, indicating which direction the user is looking and whether the object should theoretically be visible, and (c) vehicle structural information, such as the position of doors, windows, seats, roof, frame, etc.

In another example, the VCI application may determine that the object is at least partially obstructed from the field of view of the second user by identifying a movement of the second user and receiving a voice signal from the second user indicating the second user's view of the object is obstructed. For instance, the second user may move his head to try to view the object 140 and may say “I can't see it.”

In some examples, the VCI application may determine that the second user 130 is obstructed from viewing the object 140 based on a time passing from the initial identification or based on a distance between the vehicle 110 and the object 140. As the vehicle 110 travels past the object 140, the distance increases and the likelihood that the second user 130 gets a good view of the object decreases. The VCI application may use a threshold time or distance in determining that the second user is at least partially obstructed from viewing the object 140.

In response to determining that second user 130 is at least partially obstructed, the VCI application may generate a view of the object. Generating a view of the object may include generating a new view, selecting a view from a plurality of stored views, or otherwise retrieving an image of the object 140. The generated image may be an unobstructed view of the object 140, showing an angle of the object that is from the same angle as the vehicle (i.e., as if user was looking at the object 140 from the same angle as when the object was first identified.)

The VCI application may also determine a vehicle display corresponding to the second user 130, or determine a vehicle display for which the second user 130 has an unobstructed view (but which does not necessarily correspond to the second user 130). In some examples, the determined display is a vehicle window onto which an AR image can be projected, such as the side windows, front window, rear window, or sunroof window. In other examples, the determined display is a vehicle display (e.g., a center console display, rear console display, or other vehicle display).

In one example, the determined display may be the window closest to the seat position of the second user 130. In other examples, the determined display may be a window positioned between the second user 130 and the object 140, which may be a window on the opposite side of the vehicle from the second user 130.

The VCI application may then be configured to display the view of the object (which may be modified to be unobstructed) onto the determined vehicle display 134. As shown in the embodiment of FIG. 1, the identified display 134 is the passenger side of the front windshield. The VCI application uses an AR display to project an unobstructed view 142 of the object 140 onto the display 134 in front of the second user 130.

In some examples, there may be multiple second users or occupants of the vehicle that have obstructed views of the object 140. In these cases, the VCI application may use a central display or shared display which all occupants can view to present the unobstructed image of the object 140.

In some examples, the VCI application may display multiple views of the object 140, a three-dimensional model or rendering of the object 140, inside views of the object, and/or other relevant information or images related to the object 140 that can enhance the user experience. In some examples, the images may come from a database, vehicle storage or memory, or some other source. In other examples, the images may come from another vehicle via vehicle-to-vehicle (V2V) communication, particularly in a case where another vehicle has a better view of the object. The other vehicle view may transmit the view of the object for display to the users 120 and 130.)

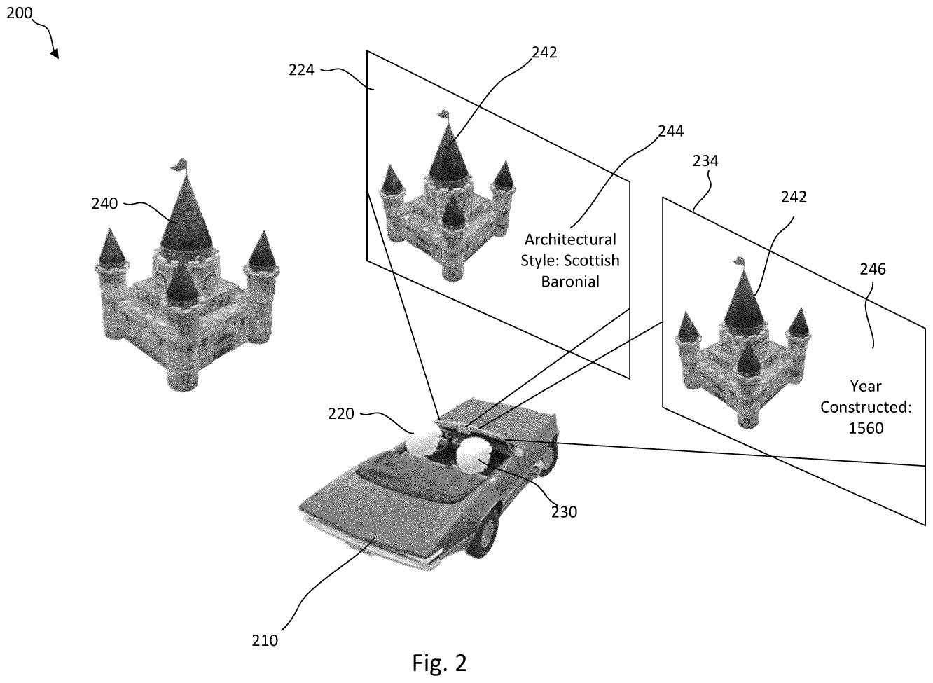

FIG. 2 depicts a second example scenario for identifying and displaying objects and related information to a user in a vehicle. Rather than waiting for movement of a user or speech from a user to identify a particular object while they are travelling, the VCI application may automatically determine the user's interests based on their user profiles and then project images and information about the objects onto displays within the vehicle. For example, if a user travelling in the vehicle is an architect, the VCI application may project an ancient building and related information onto the user's window side whenever he crosses it. In another example, multiple users in the vehicle may be interested in a particular show (e.g., Breaking Bad), and while travelling in the vehicle they cross a restaurant where one of the scenes of that series was filmed. The VCI application may project the restaurant and/or information related to the series on the vehicle windshield so that all users can view it.

In both examples noted above, and more examples noted below, the VCI application may store or obtain user profile information that includes general and/or specific interests of the users 220, 230, and/or other passengers of the vehicle 210. The user profile information can be obtained by various methods, including manual input by users, automatic input or profile building via communication or connection with other applications, services, social media profiles, etc. In some examples, the user profile information may be built or updated over time as the user operates or occupies the vehicle 110. For instance, prior objects that have been identified and/or displayed in the vehicle, as well as user interaction with or interest in those objects may be captured and stored. In one example, the VCI application may build profiles for various occupants based on past travel history, e.g., a profile for a particular occupant may include data that the occupant has observed a point-of-interest during other trips in the vehicle or other vehicles. Such data may be derived from occupant monitoring during other trips (e.g., gaze tracking and/and verbal call-outs), and from verbal input received (e.g., the user may say “I think I have seen that object before”).

The contents of the user profile or user profile information can include at least one of the user's interests, a passenger's interests, the user's social connections, the user's social connections' interests, and historical objects of interest to the user. User profiles may provide information about occupants, such as various demographic information (e.g., age range, race, ethnicity, languages spoken or understood, etc.), psychographic characteristics (e.g., lifestyle, values, interests, personality, etc.), behavioral attributes (e.g., app usage, media preferences, point-of-interest interactions, driver/passenger patterns, etc.), and physiological characteristics (e.g., height, visual and/or audio impairments, etc.).

Referring to FIG. 2, the VCI application may be configured to identify an object 240 external to the vehicle 210. The object 240 may be identified (a) without input from a user, or (b) with input from a user.

To identify the object 240 without user input, the VCI application may make use of GPS or other positioning information corresponding to the vehicle 210 and the object 240. As the vehicle travels down the road, the VCI application may identify objects that are close by the vehicle 210 and are of interest to the users 220 and/or 230 within the vehicle. In some examples, objects 240 may be ranked or ordered, such that when a given object is above some threshold of interest to a user, that object can be automatically identified. The VCI application also makes use of the user profile information to identify or exclude various objects, based on their interest to the users 220 and 230. In some examples, one or more objects may be identified based on what other users have found interesting in the past, and/or which objects have been identified for users having similar profiles to the users 220 and/or 230.

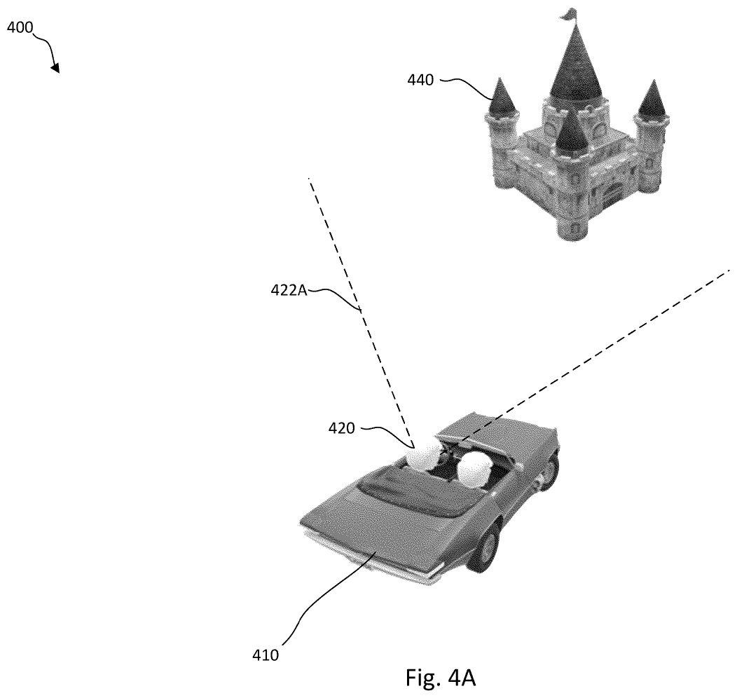

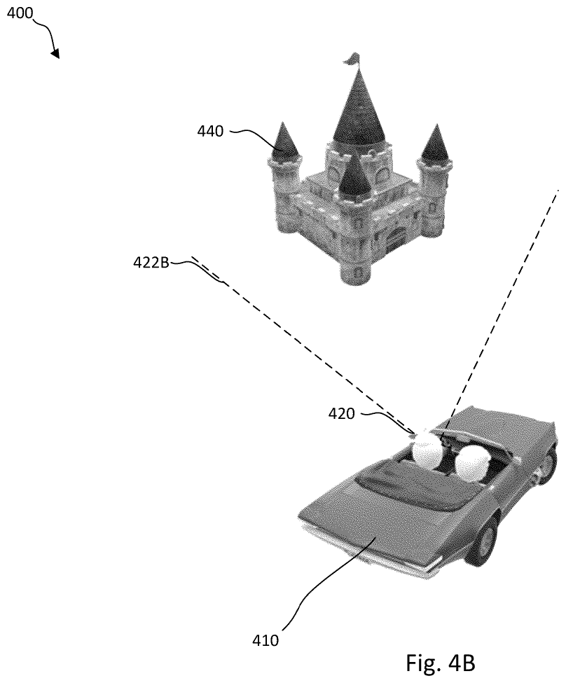

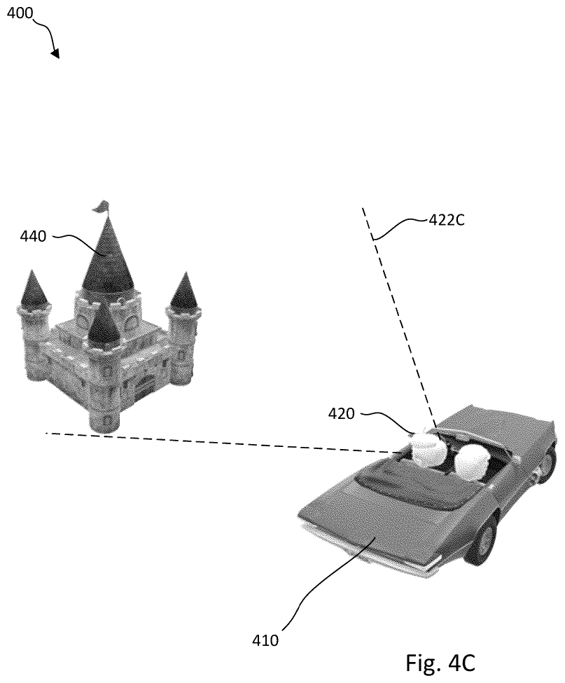

The VCI application can also identify an object external to the vehicle based at least in part on input from either or both users 220 and 230. In some examples, the VCI application may detect passive action from either user 220, user 230, or both. The passive action may include head movement, hand movement, arm movement, finger movement, body position changing, gaze changing, and more. In some examples, the VCI application may track the gaze of either or both of users 220 and 230 (described in further detail below with respect to FIGS. 4A-C). The VCI application may determine an object external to the vehicle that is included in the field of view of one of both users 220 and 230, or is in the direction of pointing or gesture of one or both users 220 and 230. In response to these determinations, the VCI application may determine a particular object that is being referenced by, pointed to, or otherwise called out by one or both users 220 and 230.

In some examples, the VCI application may identify the object based on a voice signal or multiple voice signals input by one or both users 220 and 230. In other examples, the VCI application may identify an object based on a combination of both movement and verbal inputs from one or both users. For instance, one user may point toward an object and say “what is that?,” one user may point to the object while the second user says “what is that?,” both users may point to an object, or both users may say “what is that?” As discussed above, the VCI application may identify the object by using natural language processing and image processing to determine if there are any objects in the images captured that are referenced in the received speech.

After identifying the object 240, the VCI application may access metadata related to the object. The metadata can include any information pertaining to the object and which may be of interest to one or more users, such as bibliographic information, dates last viewed by one or more users, a level of interest associated with the object and the users, and more. In the illustrated example, the object 240 may be a castle, and the related metadata can include the architectural style, the date of construction, dates the castle was attacked, renovated, or any other relevant data. In some examples, the metadata may be stored by the VCI application or vehicle or may be stored and accessed remotely by the vehicle and/or VCI application. For example, the VCI application may access metadata for the object 240 that is located on a remote server, stored locally (e.g., by storage media within the vehicle 210), captured by onboard devices (e.g., by camera equipment of the vehicle 210), captured by connected devices (e.g., by camera equipment of a mobile device within the vehicle 210 or another vehicle).

The VCI application may then identify the presence of a user within the vehicle. The VCI application identifies the presence of a user within the vehicle and may determine or identify a user profile associated with the user.

Once a user is identified, the VCI application can determine that a portion of the metadata matches the user profile information of the user. This can include comparing the metadata of the object 240 to the information included in the user profiles of each user 220 and 230. The VCI application can then determine whether the metadata for the object 240 matches or is relevant to the users 220 and/or 230. As used herein, user profile information “matching” a portion of the metadata need not be a direct one-to-one exact match but may instead be a comparison that determines whether any of the metadata would be deemed interesting to a given user based on the user's interests and user profile information.

The VCI application may also identify a display within the vehicle 210 that is viewable by each user. For example, the VCI application may identify that display 224 is viewable by user 220, and that display 234 is viewable by user 230. The VCI application may identify the display for a given user based on the user position within the vehicle 210. The display may be the closest window to the user, the window closest to the direct line between the object 240 and the user, the window on the same side of the vehicle as the object 240, the least obtrusive window option (e.g., avoiding display on the front windshield for the driver), and/or a subset of a window (e.g., only the bottom part, top part, small subset, etc.). In some examples, the VCI application may identify a display based on avoiding obstructions from other passengers or vehicle elements (e.g., avoiding displays blocked by other passengers, seats, etc.).

The VCI application is also configured to generate for display on the identified display the portion of the metadata that matches the user profile information of the user. This can include generating for display on display 224 an unobstructed image 242 of the object 240, and relevant metadata 244 that is related to interests or user profile information of user 220.

The VCI application can also identify a presence of a second user 230 within the vehicle 210, determine that a second portion of the metadata matches user profile information for the second user 230, identify a second display 234 within the vehicle 210 that is within a field of view of the second user 230, and generate for display on the second display 234 the second portion of the metadata that matches the user profile information of the second user 230.

As shown in FIG. 2, the first user 220 may have an interest in architecture, and the VCI application therefor determines that the architectural style of the object 240 is relevant to the user 220, and displays this information 244 on the display 224 for the first user 220. Additionally, the second user may have an interest in history, and the VCI application therefor determines that the date of construction of the object 240 is relevant to the second user 230 and displays this information 246 on the display 234 for the second user 230.

In some examples, there may be multiple users of the vehicle 210. In this case, the VCI application may identify one display per person (i.e., each user has a dedicated display for which he has an unobstructed view), the VCI application may identify a shared display for two or more users, or the VCI application may identify a display that is viewable only by one user (i.e., where a first user is a driver and a second user is a passenger, the VCI application may select a display that is only visible to the passenger so as to not interfere with driving).

In some examples, the VCI application may identify or select a display based on engagement of the first and second users 220 and 230 with the display. For example, as shown in FIG. 2, the display 234 may be positioned in front of the second user 230. The VCI application may select the display 234 to display the image and relevant metadata for the first user 220, rather than selecting the display 224 directly in front of the first user 220. The VCI application may determine that the second user 230 is less engaged with the second display 234 (e.g., the second user 230 is looking out the side window, is asleep, or otherwise not paying attention to the display 234) and may select the display 234 to display the information to the first user 220.

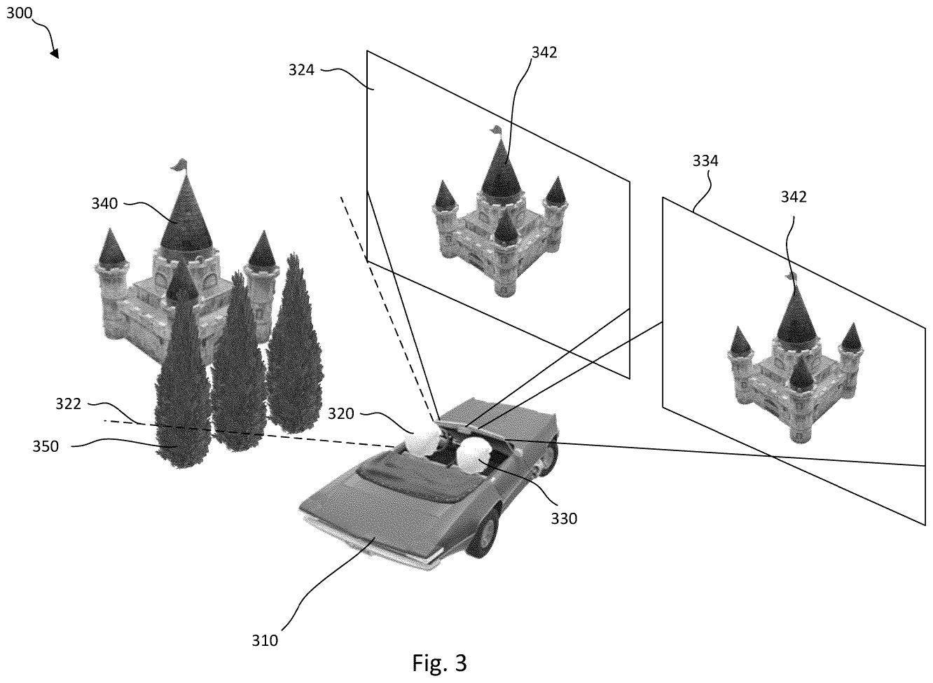

FIG. 3 depicts a third example scenario for identifying and displaying obstructed objects and/or information to a user in a vehicle. As shown in FIG. 3, a first user 320 travels in a vehicle and has an obstructed view of object 340, due to the obstruction 350 between the vehicle 310 and the object 340. The VCI application projects a view of the unobstructed object 342 onto the first display 324. The second user 330 has an obstructed view of the object 340 caused in part by the first user 320 and/or the obstruction 350, and the VCI application projects a view of the unobstructed object 342 onto the second display 334.

In the illustrated embodiment, the VCI application identifies an object in proximity to the vehicle 310 that is applicable to a user of the vehicle 310. The object may be identified in any manner described herein, and in particular in any manner described with respect to FIGS. 1 and 2. This can include identifying the object 340 based on movement of the users 320 and/or 330, voice signals received from the users 320 and/or 330, gaze detection, image analysis, natural language processing, and more.

The VCI application may identify the object 340 based on (a) movement of the user 320, (b) a voice signal received from the user 320, and/or (c) a combination of movement and voice signal. The VCI application may capture 360-degree external views from the vehicle, receive movement, voice, or other information as noted below, and correlate the movement voice or other information with the captured views to identify the external object.

As illustrated in FIG. 3, VCI application may identify the object 340 based on the object 340 being included in the field of view 322 of the user 320. In some examples, the object 340 may be identified based on movement of the user 320's hand, arm, fingers, or other movements described herein. Similar to the description above, the VCI application may detect the position and orientation of the user 320's hand, arm, or fingers, and use that information to identify the direction the user is referring to. The VCI application may then compare images taken from the vehicle in the same direction, in order to determine the most likely object external to the vehicle to which the user 320 is pointing or referring.

In some examples, the object 340 may be identified based on a voice input received from the user 320. For example, the user 320 may say “look at that castle,” “wow, did you see that?,” or any other voice signal which may help the VCI application to identify the object 340. The VCI application may perform natural language processing or speech analysis on the voice signal to determine the content of the voice signal. The content can then be analyzed to determine whether and to which object the user 320 is referring. Additionally, speech analysis and/or natural language processing can be used in combination with image processing to determine whether the received voice signal refers to any object that is in the images captured by the vehicle cameras.

In some examples, the VCI application may use both movement and voice signals from the user 320 to identify the object 340. For example, the user 320 may point at the object 340 and say, “look at that castle.” The VCI application could use both the movement data and the voice data to increase a confidence level associated with the identification of the object 340.

In some examples, the surroundings of the vehicle 310 include multiple potential objects that the VCI application may identify. The VCI application may identify one object from the plurality of possible objects in a manner similar or identical to the manner described above with respect to FIG. 1.

In some examples, the VCI application may use a predetermined hierarchy of objects to identify the likely object to which the user 320 is referring. For example, if there are multiple objects nearby each other, such as a castle, billboard, old building, and a convenience store (all within the same field of view when looking from the vehicle 310), the VCI application may rank the objects (or may access a ranking of objects) to make an assumption about which object the user 320 is likely referring to. The VCI application may have a default ranking or may use a ranking determined based on a user profile for the user 320, wherein the user's interests (e.g., the user 320 is interested in architecture) to determine that the castle is the most likely object being referenced by first user 320.

In some examples, the VCI application may be configured to identify the object 340 without input from a user. To identify the object 240 without user input, the VCI application may make use of GPS or other positioning information corresponding to the vehicle 310 and the object 340. As the vehicle travels down the road, the VCI application may identify objects that are close by the vehicle 310 and are of interest to the users 320 and/or 330 within the vehicle. In some examples, objects may be ranked or ordered, such that when a given object is above some threshold of interest to a user, that object can be automatically identified. The VCI application also makes use of the user profile information to identify or exclude various objects, based on their interest to the users 320 and 330. In some examples, one or more objects may be identified based on what other users have found interesting in the past, and/or which objects have been identified for users having similar profiles to the users 320 and/or 330.

The VCI application is also configured to determine that the object 340 is at least partially obscured from a field of view of the user 320. The VCI application can make this determination in any manner described herein, and in particular in the manner described above with respect to FIG. 1.

To determine that the object 340 is at least partially obstructed, the VCI application may use a combination of factors. In one example, the VCI application may determine a field of view 322 of the user 320. The VCI application may determine the field of view 322 in a similar manner to that described above, including through the use of cameras, gaze tracking, eye tracking, or the use of other sensors (e.g., sensor array 608 described below). The VCI application may also use the known locations of vehicle structures, positioning of the user 320 within the vehicle (e.g., whether the user 320 is on the same side or opposite side as the object 340), the position of the object 340 relative to the vehicle, and/or the presence of other objects outside the vehicle which may obscure the user's view of the object 340.

In some examples, the VCI application may determine that the user 320's view is obstructed based on a verbal signal received from the user 320. For instance, the user 320 may say “what is that?” Additionally, the VCI application may use movement of the user 320 to determine that he is obstructed (e.g., where the user keeps moving his head to attempt to see the object 340, or scans back and forth without locking onto the object 340).

In one example, the VCI application may determine that the user 320 is at least partially obstructed from viewing the object 340 based on a combination of factors. The combination of factors may include (a) a position of the user 320 inside the vehicle, and thereby whether other passengers or vehicle structures are positioned between the user 320 and the object 340, (b) a field of view 322 of the user 320, indicating which direction the user is looking and whether the object 340 should be visible, and (c) vehicle structural information, such as the position of doors, windows, seats, roof, frame, etc.

In another example, the VCI application may determine that the object 340 is at least partially obstructed from the field of view of the user 320 by identifying a movement of the user 320 and receiving a voice signal from the user 320 indicating the user's view of the object 340 is obstructed. For instance, the user 320 may move his head to try to view the object 340 and may say “I can't see it.”

In some examples, the VCI application may determine that the user 320 is obstructed from viewing the object 340 based on a time passing from the initial identification or based on a distance between the vehicle 310 and the object 340. As the vehicle 310 travels past the object 340, the distance increases and the likelihood that the user 320 gets a good view of the object decreases. The VCI application may use a threshold time or distance in determining that the user 320 is at least partially obstructed from viewing the object 340.

In some examples, the VCI application may determine that the user 320 is obstructed from viewing the object 340 by determining that one or more other external objects (e.g., hedge 350) is positioned between the user 320 and the object 340. The VCI application may analyze images taken from the vehicle in the direction of the object 340, to determine that the user 320's view is obstructed by the hedge 350.

The VCI application is also configured to identify a display within the vehicle that is viewable by the user 320. This identification may be done responsive to the VCI application determining that the object 340 is at least partially obstructed from the view of user 320. In some examples the VCI application may identify the display closest to the user 320, or a display for which the user 320 has an unobstructed view. In one example, the VCI application may identify a display that is not closest to the user 320, but rather a display which is positioned between the user 320 and the object 340. The VCI application may identify the display based on the user 320 position within the vehicle 310, the closest window to the user 320, a window in line of sight from the user 320 to the object 340, a window on the same side of the vehicle 310 as the object 340, a least obtrusive window option (i.e., avoiding the front windshield), or a subset of a window (e.g., only the bottom part, top part, etc.). The VCI application may also identify the display such that it identifies a display that is not obscured by other occupants of the vehicle.

The VCI application may also be configured to generate for display on the identified display a view of the object that is modified to be unobscured. The VCI application may generate the view of the object responsive to determining that the object 340 is at least partially obscured. Similar to the description above with respect to FIG. 1, the generation of the view of the object may include generating a new view, selecting a view from a plurality of stored views, or otherwise retrieving an image of the object 340. The generated image may be an unobstructed view of the object 340, showing an angle of the object that is from the same angle as the vehicle (i.e., as if user was looking at the object 340 from the same angle as when the object was first identified.)

In some examples, the VCI application may generate the view of the object responsive to a movement of the user 320, a voice input of the user 320, or a combination of movement and voice input. In some examples, the VCI application may display multiple views of the object 340, a three-dimensional model or rendering of the object 340, inside views of the object 340, and/or other relevant information or images related to the object 340 that can enhance the user experience. In some examples, the images may come from a database, vehicle storage or memory, or some other source. In other examples, the images may come from another vehicle via vehicle-to-vehicle (V2V) communication, particularly in a case where another vehicle has a better view of the object. The other vehicle view may transmit the view of the object for display to the users 320 and 330.)

In some examples, the VCI application may also identify a second user 330 of the vehicle 310. The VCI application may identify a presence of a second user 330 within the vehicle, determine that the object 340 is at least partially obscured to the second user 330, (e.g., using the same method as for the determination that the first user 320 is obstructed), identify a second display 334 within the vehicle 310 that is within a field of view of the second user 330 (e.g., using the same method as for the determination of the first display 324 for the first user 320), and generate for display on the second display 334 the view of the object 342 that is modified to be unobscured (e.g., using the same method as for the generation and display of the view of the object 342 on the first display 324 for the first user 320.)

FIGS. 4A-4C depict a series of views showing the changing field of view of a user of a vehicle as the vehicle 410 and user 420 travel near an object 440. This series of drawings illustrates an example which may show how a user's gaze changes over time, and how the VCI application can identify the object 440 by pairing the changing gaze with the position of the object 440 over time.

FIG. 4A illustrates a user 420 traveling in a vehicle 410, having a first field of view 422A. The object 440 is positioned off in front of and to the side of the vehicle 410 in the distance.

FIG. 4B illustrates the user 420 and vehicle 410 at a second, later point in time after the vehicle 410 has traveled a distance along the road. As the vehicle 410 travels toward the object 440, the user 420's gaze moves to include a second field of view 422B. As the user 420 turns his head slightly when the vehicle 410 approaches the object 440, the object 440 remains in the field of view 422B.

FIG. 4C illustrates a further, later moment in time at which the user 420 continues to look at the object 440. The third field of view 422C at this point continues to include the object 440.

As illustrated in the series of FIGS. 4A-C, the object 440 is included in all three of the shown fields of view 422A, 422B, and 422C. The object 440 is thus a shared object between these fields of view. The VCI application may make use of this information to determine or identify the object 440 as significant or important, as described with respect to FIGS. 1, 2, and 3.

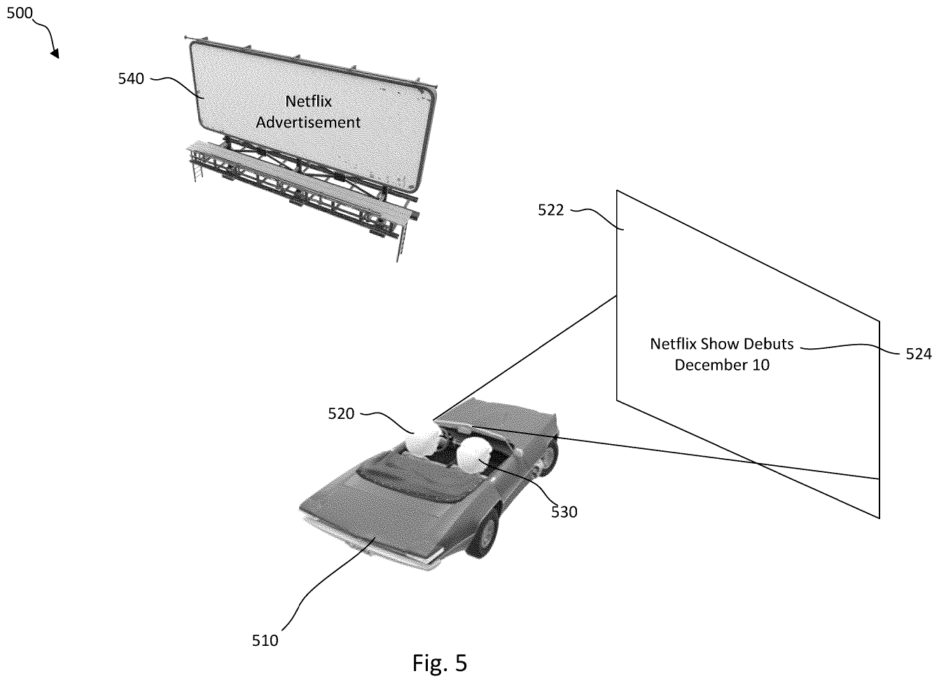

FIG. 5 depicts a fourth example scenario 500 for identifying and displaying objects and/or information to a user in a vehicle, according to aspects of the present disclosure. Billboards are one common and effective way of endorsing a product or presenting advertisements to consumers. In the illustrated example of FIG. 5, a first user 520 and a second user 530 are traveling in a vehicle 510. The vehicle 510 passes near a billboard 540 that includes an advertisement for a particular Netflix show. The billboard 540 may include a communication system, which enables the billboard to communicate with other computing devices, such as the VCI application described herein. Thus, there may be communication between the billboard 540 and the VCI application and/or vehicle 510. The billboard 540 may be a modifiable display, and may be configured to change the displayed advertisement.

The vehicle 510 and/or VCI application may communicate with the billboard 540 and fetch various information, such as what brand advertisement the billboard is currently showing or what content or program they are advertising.

In some examples, the VCI application may be configured to identify the billboard 540 and the contents of the display (i.e., Netflix advertisement). The VCI application may also be configured to identify user profiles of users 520 and 530 and any other occupants of the vehicle 510. The VCI application may then communicate with the billboard 540 to cause the billboard 540 to change the advertisement displayed based on the interests of the users 520 and 530 and their respective user profile information. The billboard 540 can then update the displayed advertisement when the next vehicle approaches with different users. Alternatively or additionally, the billboard can weigh the overall best advertisement to display given all nearby users, or the most common interest between users, or based on some other factors.

In some examples, the VCI application can display the same advertisement or a corresponding advertisement for the same show (or different show) by projecting onto one or more windows of the vehicle 510. In other examples, the VCI application may retrieve additional information to be displayed on one or more internal vehicle displays such as display 522 (i.e., additional information 524 that complements the advertisement shown on the billboard 540 showing the debut date of the show included on the billboard 540.

In some examples, the interests of the user 520 may align with the displayed advertisement on the billboard 540. In this case, the AR devices may project the advertisement on the vehicle's windows. Alternatively, if the user interests do not align, the AR devices may project a different advertisement for another show of the same brand based on their interests. For example, we can show them a different Netflix show advertisement, and/or other related information.

In some examples, the billboard 540 may operate as a green screen. The advertisement or other information targeted to one or more of the occupants of the vehicle may be generated on an AR display of the vehicle over or tracking the position of the billboard (i.e., green screen). As the vehicle moves with respect to the billboard 540, the advertisement or other information may be displayed by the AR display of the vehicle and may appear to the vehicle occupant as if the advertisement or information is being displayed on the green screen itself.

Referring to the examples illustrated in FIGS. 1-5, in some embodiments the VCI application may monitor and track multiple users of the vehicle. In other examples, the VCI application may only monitor and track those occupants that may be interested in a particular object. For instance, the VCI application may not track or use movement information from sleeping occupants, babies, children under a certain age, etc. Additionally, the VCI application may monitor sleep or movement of all users, and only begin factoring in user movement when a given user wakes up (e.g., tracking head movement, gaze, etc.).

In some examples, the VCI application may determine whether a given user has viewed an object if the gaze of the user is stable and generally tracks the identified object as the vehicle and/or the object moves. Alternatively, the VCI application system may determine that a user did not observe the identified object if the gaze of the user is scanning around the external environment without focusing on the identified object.

In some examples, one or more occupants may provide verbal indication of whether they observed the identified object, e.g., “I did. That was a nice house.” or “Cool camel!” or “What? Where?!” or “No, but I have seen that before.” The VCI application may analyze such speech to help determine that the other occupant did or did not see the identified object, and a level of interest of the occupant in viewing the object.

In some examples, the integrated system or VCI application may be utilized in scenarios beyond a typical consumer vehicle shown in the drawings. In some embodiments, the vehicle may be a bus, train, airplane, boat, and the like, that incorporates the integrated system or VCI application, such as in a tour guide scenario. The integrated system or VCI application may also be implemented across multiple different vehicles to display an object called-out from one vehicle at another vehicle with interested occupants.

FIG. 6 depicts example devices and related hardware for enhancing in-vehicle experiences based on objects eternal to the vehicle, in accordance with some embodiments of the disclosure. A user or occupant in a vehicle may access content and the vehicle content interface VCI application (and its display screens described above and below) from one or more of their user equipment devices. FIG. 6 shows a generalized embodiment of illustrative user equipment device 600. User equipment device 600 may receive content and data via input/output (I/O) path 616, and may process input data and output data using input/output circuitry (not shown). I/O path 616 may provide content (e.g., broadcast programming, on-demand programming, Internet content, content available over a local area network (LAN) or wide area network (WAN), and/or other content) and data to control circuitry 612, which includes processing circuitry 610 and storage 614. Control circuitry 612 may be used to send and receive commands, requests, and other suitable data using I/O path 616.

Control circuitry 612 may be based on any suitable processing circuitry such as processing circuitry 610. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, processing circuitry may be distributed across multiple separate processors or processing units. In some embodiments, control circuitry 612 executes instructions for a vehicle content interface application stored in non-volatile memory (i.e., storage 614). Specifically, control circuitry 612 may be instructed by the vehicle content interface application to perform the functions discussed above and below. For example, the vehicle content interface application may provide instructions to control circuitry 612 to identify and display obscured objects and related information to users in a vehicle. In some implementations, any action performed by control circuitry 612 may be based on instructions received from the vehicle content interface application.

In client/server-based embodiments, control circuitry 612 may include communications circuitry suitable for communicating with a content application server or other networks or servers. The instructions for carrying out the above-mentioned functionality may be stored on the content application server. Communications circuitry may include a cable modem, an integrated-services digital network (ISDN) modem, a digital subscriber line (DSL) modem, a telephone modem, Ethernet card, or a wireless modem for communications with other equipment, or any other suitable communications circuitry. Such communications may involve the Internet or any other suitable communications networks or paths (which are described in more detail in connection with FIG. 7). In some embodiments, a sensor array 608 is provided in the user equipment device 600. The sensor array 608 may be used for gathering data and making various determinations and identifications as discussed in this disclosure. The sensor array 608 may include various sensors, such as one or more cameras, microphones, ultrasonic sensors, and light sensors, for example. The sensor array 608 may also include sensor circuitry which enables the sensors to operate and receive and transmit data to and from the control circuitry 612 and various other components of the user equipment device 600. In addition, communications circuitry may include circuitry that enables peer-to-peer communication of user equipment devices, or communication of user equipment devices in locations remote from each other (described in more detail below).

Memory may be an electronic storage device provided as storage 614 that is part of control circuitry 612. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Storage 614 may be used to store various types of content described herein as well as content data and content application data that are described above. Nonvolatile memory may also be used (e.g., to launch a boot-up routine and other instructions). Cloud-based storage may be used to supplement storage 614 or instead of storage 614.

Control circuitry 612 may include video generating circuitry and tuning circuitry, such as one or more analog tuners, one or more MPEG-2 decoders or other digital decoding circuitry, high-definition tuners, or any other suitable tuning or video circuits or combinations of such circuits. Encoding circuitry (e.g., for converting over-the-air, analog, or digital signals to MPEG signals for storage) may also be provided. Control circuitry 612 may also include scaler circuitry for upconverting and down-converting content into the preferred output format of the user equipment device 600. Control Circuitry 612 may also include digital-to-analog converter circuitry and analog-to-digital converter circuitry for converting between digital and analog signals. The tuning and encoding circuitry may be used by the user equipment device to receive and to display, play, or record content. In some embodiments, the control circuitry may include an HD antenna.

In one embodiment, speakers 606 may be provided as integrated with other elements of user equipment device 600 or may be stand-alone units. The audio and other content displayed on display 604 may be played through speakers 606. In some embodiments, the audio may be distributed to a receiver (not shown), which processes and outputs the audio via speakers 606.

In some embodiments, the sensor array 608 is provided in the user equipment device 600. The sensor array 608 may be used to monitor, identify, and determine vehicle status data. For example, the vehicle content interface application may receive vehicle status data from the sensor or any other vehicle status data (e.g., global positioning data of the vehicle, driving condition of the vehicle, etc.) received from any other vehicular circuitry and/or component that describes the status of the vehicle.

The vehicle content interface application may be implemented using any suitable architecture. For example, it may be a stand-alone application wholly implemented on user equipment device 600. In such an approach, instructions of the application are stored locally (e.g., in storage 614), and data for use by the application is downloaded on a periodic basis (e.g., from an out-of-band feed, from an Internet resource, or using another suitable approach). Control circuitry 612 may retrieve instructions of the application from storage 614 and process the instructions to generate any of the displays discussed herein. Based on the processed instructions, control circuitry 612 may determine what action to perform when input is received from input interface 602. For example, the movement of a cursor on an audio user interface element may be indicated by the processed instructions when input interface 602 indicates that a user interface 602 was selected.

In some embodiments, the vehicle content interface application is a client/server-based application. Data for use by a thick or thin client implemented on user equipment device 600 is retrieved on-demand by issuing requests to a server remote to the user equipment device 600. In one example of a client/server-based content application, control circuitry 612 runs a web browser that interprets web pages provided by a remote server. For example, the remote server may store the instructions for the application in a storage device. The remote server may process the stored instructions using circuitry (e.g., control circuitry 612) and generate the displays discussed above and below. The client device may receive the displays generated by the remote server and may display the content of the displays locally on user equipment device 600. This way, the processing of the instructions is performed remotely by the server while the resulting displays are provided locally on user equipment device 600. User equipment device 600 may receive inputs from the user or occupant of the vehicle via input interface 602 and transmit those inputs to the remote server for processing and generating the corresponding displays. For example, user equipment device 600 may transmit, via one or more antenna, communication to the remote server, indicating that a user interface element was selected via input interface 602. The remote server may process instructions in accordance with that input and generate a display of content identifiers associated with the selected user interface element. The generated display is then transmitted to user equipment device 600 for presentation to the user or occupant of the vehicle.

In some embodiments, the vehicle content interface application is downloaded and interpreted or otherwise run by an interpreter or virtual machine (run by control circuitry 612). In some embodiments, the vehicle content interface application may be encoded in the ETV Binary Interchange Format (EBIF), received by control circuitry 612 as part of a suitable feed, and interpreted by a user agent running on control circuitry 612. For example, the vehicle content interface application may be an EBIF application. In some embodiments, the vehicle content interface application may be defined by a series of JAVA-based files that are received and run by a local virtual machine or other suitable middleware executed by control circuitry 612. In some of such embodiments (e.g., those employing MPEG-2 or other digital media encoding schemes), the vehicle content interface application may be, for example, encoded and transmitted in an MPEG-2 object carousel with the MPEG audio of a program.

User equipment device 600 of FIG. 6 can be implemented in system 700 of FIG. 7 as vehicle media equipment 714, vehicle computer equipment 718, wireless user communications device 722 or any other type of user equipment suitable for accessing content, such as a non-portable gaming machine. For simplicity, these devices may be referred to herein collectively as user equipment or user equipment devices and may be substantially similar to user equipment devices described above. User equipment devices, on which a vehicle content interface application may be implemented, may function as stand-alone devices or may be part of a network of devices. Various network configurations of devices may be implemented and are discussed in more detail below.

FIG. 7 depicts example systems, servers and related hardware for enhancing in-vehicle experiences based on objects eternal to the vehicle, in accordance with some embodiments of the disclosure. A user equipment device utilizing at least some of the system features described above in connection with FIG. 7 may not be classified solely as vehicle media equipment 714, vehicle computer equipment 716, or a wireless user communications device 722. For example, vehicle media equipment 714 may, like some vehicle computer equipment 716, be Internet-enabled, allowing for access to Internet content, while wireless user computer equipment 722 may, like some vehicle media equipment 714, include a tuner allowing for access to media programming. The vehicle content interface application may have the same layout on various types of user equipment or may be tailored to the display capabilities of the user equipment. For example, on wireless user computer equipment 716, the vehicle content interface application may be provided as a website accessed by a web browser. In another example, the vehicle content interface application may be scaled down for wireless user communications devices 722.

The user equipment devices may be coupled to communications network 710. Communications network 710 may be one or more networks including the Internet, a mobile phone network, mobile voice or data network (e.g., a 4G, 5G or LTE network), cable network, public switched telephone network, or other types of communications network or combinations of communications networks.

System 700 includes content source 702 and vehicle content interface data source 704 coupled to communications network 710. Communications with the content source 702 and the data source 704 may be exchanged over one or more communications paths but are shown as a single path in FIG. 7 to avoid overcomplicating the drawing. Although communications between sources 702 and 704 with user equipment devices 714, 716, and 722 are shown through communications network 710, in some embodiments, sources 702 and 704 may communicate directly with user equipment devices 714, 716, and 722.

Content source 702 may include one or more types of content distribution equipment including a media distribution facility, satellite distribution facility, programming sources, intermediate distribution facilities and/or servers, Internet providers, on-demand media servers, and other content providers. Vehicle content interface data source 704 may provide content data, such as the audio described above. Vehicle content interface application data may be provided to the user equipment devices using any suitable approach. In some embodiments, vehicle content interface data from vehicle content interface data source 704 may be provided to users' equipment using a client/server approach. For example, a user equipment device may pull content data from a server, or a server may present the content data to a user equipment device. Data source 704 may provide user equipment devices 714, 716 and 722 the vehicle content interface application itself or software updates for the vehicle content interface application.

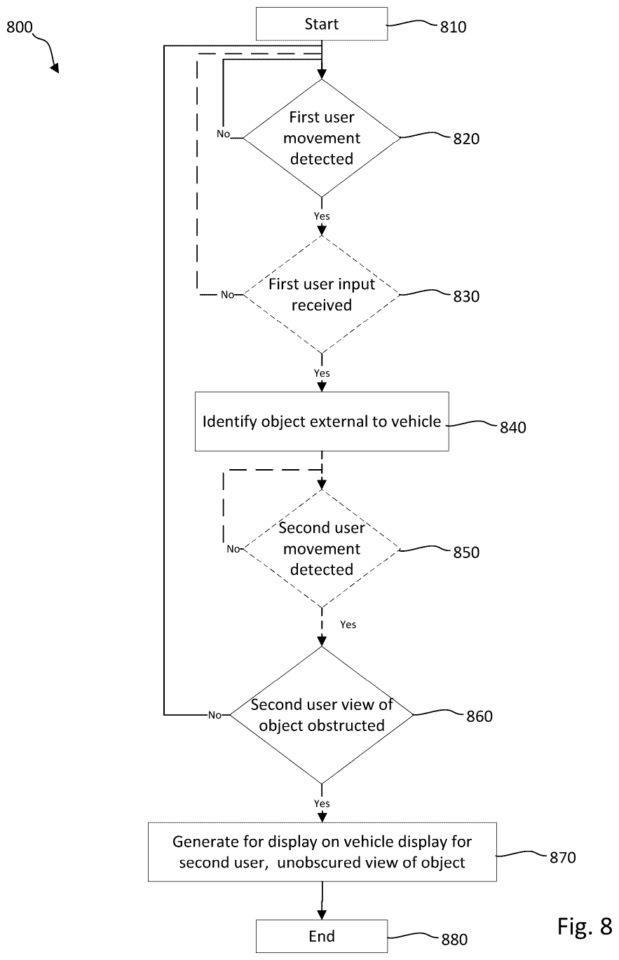

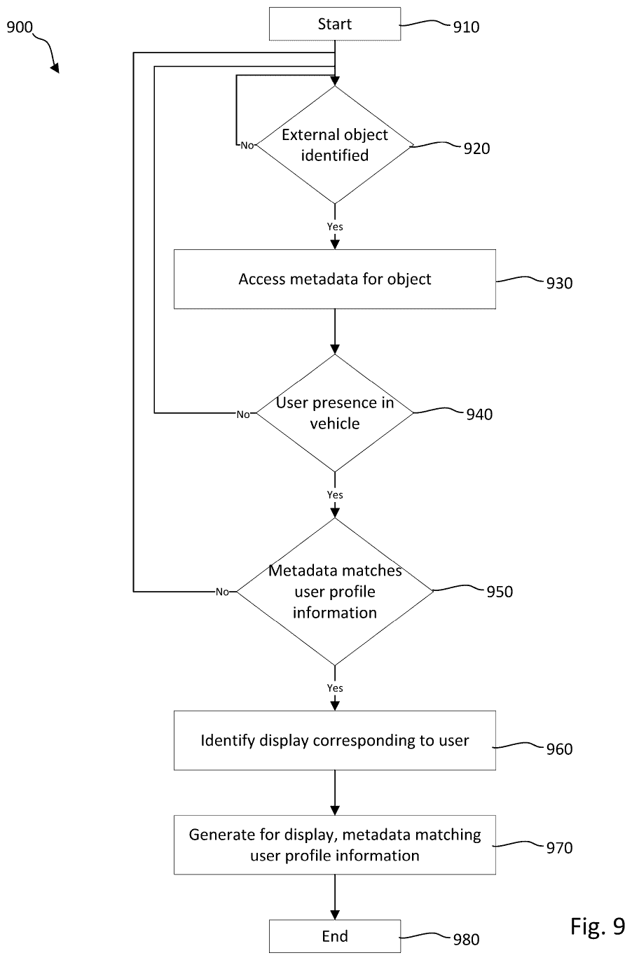

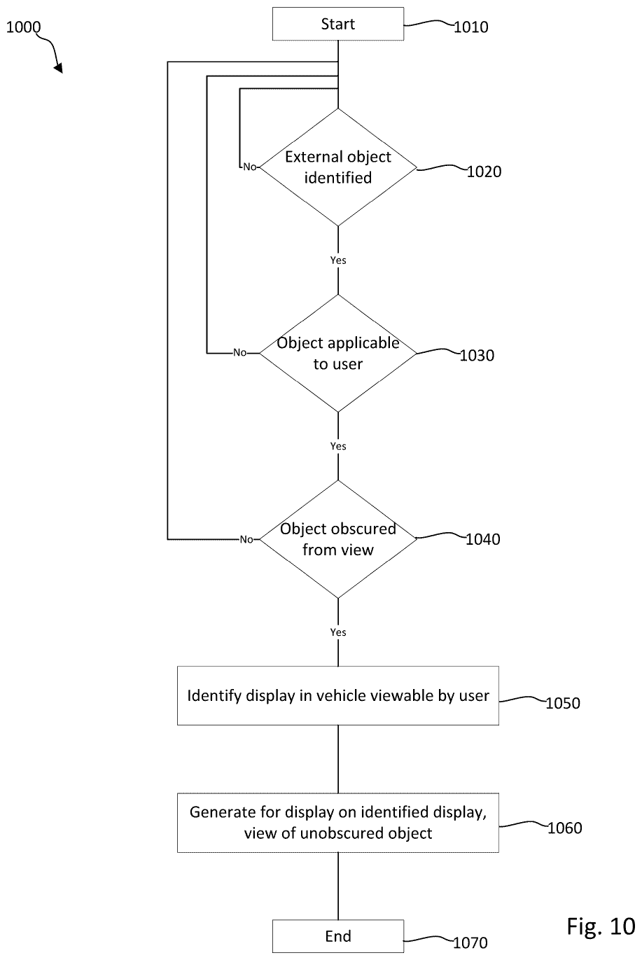

FIG. 8 is a flowchart of an illustrative process for identifying and displaying obscured objects to a user in a vehicle, in accordance with some embodiments of the disclosure. As shown in FIG. 8, in accordance with some embodiments, a process 800 may be executed by processing circuitry 600 of a vehicle (FIG. 6). It should be noted that process 800 or any step thereof could be performed on, or provided by, the system of FIGS. 6 and 7 or any of the devices shown in FIGS. 1-5. In addition, one or more steps of process 800 may be incorporated into or combined with one or more other steps described herein (e.g., incorporated into steps of processes 900 or 1000 of FIGS. 9 and 10). For example, process 800 may be executed by control circuitry 612 of FIG. 6 as instructed by a vehicle content interface application implemented on a user device in order to present views of objects external to a vehicle and related information to users of the vehicle. Also, one or more steps of process 800 may be incorporated into or combined with one or more steps of any other process or embodiment.

At step 810, the process 800 of identifying and displaying obscured objects to a user of a vehicle begins. As non-limiting examples, process 800 may begin at vehicle startup, based on a user selection via a vehicle user interface, based on detection of a particular user in the vehicle, or via an automatic initiation based on the detection of an event (e.g., vehicle speed above some threshold).

At step 820, a control circuitry (e.g., control circuitry 612 when executing instructions of the VCI application stored in memory 614) identifies a movement of a first user of a vehicle. As noted above, identifying movement of a first user of a vehicle can include identifying movement of the user's head, arm, hand, fingers, eyes, gaze direction, body position, or any other suitable movement of the user. In some examples, the sensor circuitry alone or in combination with the control circuitry may be used to identify the movement of the first user. If the sensor circuitry and/or control circuitry does not detect movement, the process 800 continues to monitor for a movement.

At step 830, if the sensor circuitry and/or control circuitry detects movement of the first user at step 820, the control circuitry determines whether first user input has been received. The first user input can include a voice or audio input, such as “look at that castle.” In some examples, the sensor circuitry and/or the control circuitry may receive the voice or audio input. If the sensor circuitry and/or control circuitry does not receive user input at optional step 830, the process may revert back to step 820 to monitor for further movement of the first user.

At step 840, the process includes the sensor circuitry and/or control circuitry identifying an object external to the vehicle. The object may also be referenced by the movement of the first user. Step 840 can be performed in response to the sensor circuitry and/or control circuitry detecting movement of the first user at step 820 (i.e., circumventing step 830), or can be performed in response to the sensor circuitry and/or control circuitry detecting a first user input received at step 830. At step 840, the sensor circuitry and/or control circuitry identifying the object external to the vehicle and referenced by the movement of the first user can include the sensor circuitry and/or control circuitry analyzing the movement of the user to determine the direction of the user's gaze, field of view, arm, hand, or finger, pointing, or otherwise determine which object the user is referring to based on the movement of the user. Example implementations of this technique are discussed in further detail above with respect to FIGS. 1-5.

At step 850, the process 800 includes an optional step of the sensor circuitry and/or control circuitry determining whether second user movement has been detected. The second user movement may be similar or identical to the first user movement, including head, eye, gaze, arm, hand, finger, or other body movements of the second user. The sensor circuitry and/or control circuitry can use this information to further identify the object external to the vehicle, and/or to increase a confidence level associated with the identification of the object. If the sensor circuitry and/or control circuitry does not detect second movement at optional step 850, the process may include continuing at step 850 until a second movement is detected.

At step 860, the process includes the sensor circuitry and/or control circuitry determining whether the second user's view of the object identified at step 840 is obstructed. This can include the sensor circuitry and/or control circuitry determining whether the object is at least partially obstructed from a field of view of a second user. Step 860 can be performed in response to the sensor circuitry and/or control circuitry identifying the object external to the vehicle at step 840 (i.e., circumventing step 850), or can be performed in response to the sensor circuitry and/or control circuitry detecting movement of the second user at step 850. At step 860, determining whether the object is at least partially obstructed from the field of view of the second user can include the sensor circuitry and/or control circuitry analyzing the movement of the second user to determine whether the second user is scanning for or locked onto the object, receiving audio or voice signals indicating that the second user has an obstructed view, analyzing the second user's position relative to the object, other users, and vehicle structural elements, or otherwise determining based on various factors that the second user has an obstructed view. Example implementations of this technique are discussed in further detail above with respect to FIGS. 1-5.

If the second user does not have an obstructed view (i.e., the user is able to see the object), the process 800 may include proceeding back to step 820 to monitor for further movement.

However, if the second user is obstructed, the process 800 proceeds to step 870. At step 870, the process includes the control circuitry or other circuitry (such as the I/O circuitry noted above with respect to FIG. 6) generating an unobscured view of the object for display on a display (such as display 604 of FIG. 6) corresponding to the second user. Example implementations of this technique are described in further detail above with respect to FIGS. 1-5.

In some examples, the process 800 then ends at step 880. In other examples, the process 800 may end under certain conditions, including when the vehicle is turned off, when the user turns off the process via interaction with a vehicle user interface, when the vehicle travels a certain distance away from the object, and/or under various other circumstances. In still other examples, the process 800 runs on a loop and continues back to the start at step 810 until the vehicle is turned off.

In some embodiments, the process 800 may include further steps described in this disclosure. For example, the process 800 may include additional steps such as identifying a particular display corresponding to the second user, and displaying the unobscured view of the object to the second user using I/O circuitry coupled to the control circuitry.

FIG. 9 is a flowchart of another detailed illustrative process for identifying and displaying obscured objects and related information to a user in the vehicle, in accordance with some embodiments of the disclosure. As shown in FIG. 9, in accordance with some embodiments, a process 900 may be executed by processing circuitry 600 of a vehicle (FIG. 6). It should be noted that process 900 or any step thereof could be performed on, or provided by, the system of FIGS. 6 and 7 or any of the devices shown in FIGS. 1-5. In addition, one or more steps of process 900 may be incorporated into or combined with one or more other steps described herein (e.g., incorporated into steps of processes 800 or 1000 of FIGS. 8 and 10). For example, process 900 may be executed by control circuitry 612 of FIG. 6 as instructed by a vehicle content interface application implemented on a user device in order to present views of objects external to a vehicle and related information to users of the vehicle. Also, one or more steps of process 900 may be incorporated into or combined with one or more steps of any other process or embodiment herein.

At step 910, the process 900 of identifying and displaying obscured objects and related information to a user of a vehicle begins. As non-limiting examples, process 900 may begin at vehicle startup, based on a user selection via a vehicle user interface, based on detection of a particular user in the vehicle, or via an automatic initiation based on the detection of an event (e.g., vehicle speed above some threshold).

At step 920, a control circuitry (e.g., control circuitry 612 when executing instructions of the VCI application stored in memory 614) determines whether an object external to the vehicle has been identified. Identifying the object external to the vehicle can be performed based on detected movement of a user or without detecting movement of a user of the vehicle. In some examples, sensor circuitry alone, or a combination of the control circuitry and the sensor circuitry operate together to identify the object. Example implementations of this technique are discussed in further detail above, in particular with respect to FIG. 2. If the sensor circuitry and/or control circuitry does not identify an object, the process 900 remains at step 920 determining whether an object has been identified.

If the sensor circuitry and/or control circuitry identifies an object external to the vehicle step 920, the process 900 includes the control circuitry accessing metadata for the object at step 930. This can include the control circuitry accessing locally stored information about the object, information stored remotely on a server, or any other source of information about the object.

At step 940, process 900 includes the sensor circuitry and/or control circuitry identifying the presence of a user within the vehicle. This can include using one or more vehicle sensors such as cameras, weight sensors, other sensors included in the sensor array 608 of FIG. 6, to determine whether a user is present in the vehicle, where the user is positioned, and various other information about the user. The process 900 may also include the control circuitry determining a user profile including user interests the profile being associated with the user identified at step 940.

If the sensor circuitry and/or control circuitry does not detect the presence of a user in the vehicle, the process proceeds back to step 920 to determine whether another object has been identified. If the sensor circuitry and/or control circuitry detects the presence of a user at step 940, the process 900 proceeds to step 950. At step 950, the process 900 includes the control circuitry determining whether a portion of the metadata corresponding to the object matches user profile information of the user. This can include the control circuitry making a determination whether the object, or any information related to the object, would be of interest to the user, and therefore warrants presentation to the user. If no metadata matches or is deemed to rise above an interest threshold for the user, the process 900 proceeds back to step 920.

However, if the metadata or a portion of the metadata of the object matches the user profile information, or rises above an interest threshold, the process proceeds to step 960. At step 960, the process 900 includes the sensor circuitry and/or control circuitry identifying a display within the vehicle that is viewable by the user. This identified display may be a vehicle display, may be a window closest to the user, or may be some other window or display for which the user has an unobstructed view. Example implementations of this determination are discussed in further detail above with respect to FIGS. 1-5.

At step 970, the process includes the control circuitry and/or input output circuitry generating for display on the identified display, the metadata matching the user profile information. Example implementations of this technique are discussed above with respect to FIGS. 1-5, and can include the control circuitry (or input/output circuitry) selecting an unobscured image of the object and selecting a subset of the available metadata associated with the object that is relevant to the interests of the particular user.

In some examples, the process 900 may then end at step 980. In other examples, the process 900 may end under certain conditions, including when the vehicle is turned off, when the user turns off the process via interaction with a vehicle user interface, when the vehicle travels a certain distance away from the object, and/or under various other circumstances. In still other examples, the process 900 runs on a loop and continues back to the start at step 910 until the vehicle is turned off.

In some embodiments, the process 900 may include further steps described in this disclosure. For example, the process 900 may include additional steps such as the control circuitry and/or input/output circuitry displaying the unobscured view of the object and/or relevant metadata to the second user on the identified display such as display 604 of FIG. 6.

FIG. 10 is a flowchart of another detailed illustrative process for identifying and displaying obscured objects and related information to a user in the vehicle, in accordance with some embodiments of the disclosure. As shown in FIG. 10, in accordance with some embodiments, a process 1000 may be executed by processing circuitry 600 of a vehicle (FIG. 6). It should be noted that process 1000 or any step thereof could be performed on, or provided by, the system of FIGS. 6 and 7 or any of the devices shown in FIGS. 1-5. In addition, one or more steps of process 1000 may be incorporated into or combined with one or more other steps described herein (e.g., incorporated into steps of process 800 or 900 of FIGS. 8 and 9). For example, process 1000 may be executed by control circuitry 612 of FIG. 6 as instructed by a vehicle content interface application implemented on a user device in order to present views of objects external to a vehicle and related information to users of the vehicle. Also, one or more steps of process 1000 may be incorporated into or combined with one or more steps of any other process or embodiment herein.

At step 1010, the process 1000 of identifying and displaying obscured objects and related information to a user of a vehicle begins. As non-limiting examples, process 1000 may begin at vehicle startup, based on a user selection via a vehicle user interface, based on detection of a particular user in the vehicle, or via an automatic initiation based on the detection of an event (e.g., vehicle speed above some threshold).

At step 1020, a control circuitry (e.g., control circuitry 612 when executing instructions of the VCI application stored in memory 614) identifies an object external to the vehicle. In some examples, sensor circuitry alone, or a combination of the control circuitry and the sensor circuitry operate together to identify the object. This may include the sensor circuitry and/or control circuitry identifying an object in proximity of the vehicle, or within a threshold distance from the vehicle. This may also include the sensor circuitry and/or control circuitry determining objects that have a sufficient level of interest associated with them (i.e., identifying only landmarks or notable objects, rather than identifying each rock or tree). If the sensor circuitry and/or control circuitry does not identify an object, the process 1000 remains at step 1020 to identify a suitable object.

If the sensor circuitry and/or control circuitry does identify an object at step 1020, the process 1000 proceeds to step 1030 wherein the process includes the control circuitry determining whether the identified object is applicable or relevant to a user of the vehicle. This can include the control circuitry accessing metadata of the object to determine whether the metadata matches any profile information or interests of the user. Example implementations of this technique are described in further detail above with respect to FIG. 3. If the object is not relevant or applicable to the user, the process proceeds back to step 1020 to continue identifying additional objects.

If the sensor circuitry and/or control circuitry identifies the object and determines the object to be applicable to the user at step 1030, the process proceeds to step 1040. At step 1040, the process includes the sensor circuitry and/or control circuitry determining whether the object is at least partially obscured from a view of the user. This can be performed in any suitable manner, and example implementations of this determination are discussed in further detail above with respect to FIGS. 1-5. If the object is not obscured from view of the user (i.e., the user has a good view of the object), then the method may proceed back to step 1020 to identify the next object of relevance.

If the sensor circuitry and/or control circuitry determines the object to be obscured at least partially from the view of the user, the process 1000 proceeds to step 1050. At step 1050, the process includes the sensor circuitry and/or control circuitry identifying a display within the vehicle that is viewable by the user, such as display 604 of FIG. 6. The identified display may be a vehicle display, may be a window closest to the user, or may be some other window or display for which the user has an unobstructed view. Example implementations of this determination are discussed in further detail above with respect to FIGS. 1-5.

At step 1060, process 1000 includes the control circuitry and/or input/output circuitry generating for display on the identified display, an unobscured view of the identified object. Exemplary implementations of this technique are described in further detail above with respect to FIGS. 1-5.

In some examples, the process 1000 then ends at step 1070. In other examples, the process 1000 may end under certain conditions, including when the vehicle is turned off, when the user turns off the process via interaction with a vehicle user interface, when the vehicle travels a certain distance away from the object, and/or under various other circumstances. In still other examples, the process 1000 runs on a loop and continues back to the start at step 1010 until the vehicle is turned off.

In some embodiments, the process 1000 may include further steps described in this disclosure. For example, the process 1000 may include additional steps such as the control circuitry and/or input/output circuitry displaying the unobscured view of the object and/or relevant metadata to the user on the identified display.

It is contemplated that the steps or descriptions of FIGS. 8-10 may be used with any other embodiment of this disclosure. In addition, the steps and descriptions are described in relation to FIGS. 8-10 may be done in alternative orders or in parallel to further the purposes of this disclosure. Any of these steps may also be skipped or omitted from the process. Furthermore, it should be noted that any of the devices or equipment discussed in relation to FIGS. 6-7 could be used to perform one or more of the steps in FIGS. 8-10.

While the examples and embodiments above are described with respect to a physical environment (e.g., a user or users traveling within a vehicle and objects external to the vehicle), it should be appreciated that the same concepts, features, and functions described herein may also apply to a user or users operating within an AR/VR environment. For example, a user may be operating an AR/VR system as a vehicle simulator, including a digital vehicle and digital objects. The same principles described above may also apply in this digital environment. For instance, objects in the AR/VR environment may be identified, and unobscured views and information about the objects may be displayed to the user through the same AR/VR environment. While the user may not physically travel past the objects, the AR/VR environment may include relative movement, such that objects appear to travel past the user when the user is operating within the AR/VR environment. It should be appreciated that the same or similar functionality described above with respect to the physical environment of a vehicle and external may also apply in the AR/VR environment.

Similarly, while embodiments herein are described with reference to a vehicle, it should be appreciated that the same functionality may be applied in a situation where there is no physical vehicle. For example, in an AR/VR environment noted above. Additionally, the methods, systems, and functions described herein may be applicable to a stationary user (e.g., a user not in a vehicle), as well as a user who is travelling in something other than a vehicle. Furthermore, in some examples the methods systems and functions described above may apply to a user who is walking, and using an AR/VR display, a phone display, a tablet display, or some other portable display.

As used herein, “a vehicle content interface application” refers to a system or application that enables the actions and features described in this disclosure. In some embodiments, the vehicle content interface application may be provided as an online application (i.e., provided on a website), or as a stand-alone application on a server, user device, etc. The vehicle content interface application may also communicate with a vehicle antenna array or telematics array to receive content via a network. In some embodiments, the vehicle content interface application and/or any instructions for performing any of the embodiments discussed herein may be encoded on computer-readable media. Computer-readable media includes any media capable of storing instructions and/or data. The computer-readable media may be transitory, including, but not limited to, propagating electrical or electromagnetic signals, or may be non-transitory, including, but not limited to, volatile and nonvolatile computer memory or storage devices such as a hard disk, floppy disk, USB drive, DVD, CD, media card, register memory, processor caches, random access memory (RAM), etc.

As referred to herein, the phrase “in response” should be understood to mean automatically, directly and immediately as a result of, without further input from the user, or automatically based on the corresponding action where intervening inputs or actions may occur.

The processes described above are intended to be illustrative and not limiting. One skilled in the art would appreciate that the steps of the processes discussed herein may be omitted, modified, combined, and/or rearranged, and any additional steps may be performed without departing from the scope of the invention. More generally, the above disclosure is meant to be exemplary and not limiting. Only the claims that follow are meant to set bounds as to what the present invention includes. Furthermore, it should be noted that the features and limitations described in any one example may be applied to any other example herein, and flowcharts or examples relating to one example may be combined with any other example in a suitable manner, done in different orders, or done in parallel. In addition, the systems and methods described herein may be performed in real time. It should also be noted that the systems and/or methods described above may be applied to, or used in accordance with, other systems and/or methods.

1. A method comprising:
identifying a movement of a first user of a vehicle;
identifying an object referenced by the movement of the first user, wherein the object is external to the vehicle; and
in response to determining that the object is at least partially obstructed from a field of view of a second user of the vehicle: generating, for display on a display within the vehicle that is within the field of view of the second user, a view of the object.

2. The method of claim 1, further comprising receiving a first voice input from the first user, wherein identifying the object external to the vehicle is performed based on (a) the movement of the first user and (b) the first voice input.

3. The method of claim 1, wherein identifying the object external to the vehicle comprises detecting movement of the first user's head toward the object.

4. The method of claim 1, wherein identifying the object external to the vehicle comprises detecting movement of the first user's hand toward the object.

5. The method of claim 1, wherein identifying the object external to the vehicle comprises determining that the object external to the vehicle is included in a field of view of the first user.

6. The method of claim 5, wherein identifying the object external to the vehicle comprises:
determining the field of view of the first user;
determining one or more potential objects within the field of view of the first user; and
selecting the object external to the vehicle from the one or more potential objects based on a voice input received from the first user.

7. The method of claim 1, wherein the determining that the object is at least partially obstructed from the field of view of the second user is performed based on (a) a position of the second user inside the vehicle, (b) a field of view of the second user, and (c) vehicle structural information.

8. The method of claim 1, wherein the determining that the object is at least partially obstructed from the field of view of the second user comprises:
identifying a movement of the second user; and
receiving a voice signal from the second user indicating the second user's view of the object is obstructed.

9. The method of claim 1, further comprising:
modifying the view of the object to be an unobstructed view of the object; and
displaying the unobstructed view of the object on a window of the vehicle closest to the second user.

10. The method of claim 1, further comprising:
modifying the view of the object to be an unobstructed view of the object; and
displaying the unobstructed view of the object on a window of the vehicle positioned between the second user and the object external to the vehicle.

11. The method of claim 1, further comprising:
accessing metadata for the object;
determining that a portion of the metadata matches user profile information of the second user; and
generating, for display on the display within the vehicle that is within the field of view of the second user, the portion of the metadata that matches the user profile information of the second user.

12. The method of claim 11, further comprising:
determining that a second portion of the metadata matches user profile information of the first user;
identifying a second display within the vehicle that is within a field of view of the first user; and
generating for display on the second display, the second portion of the metadata that matches the user profile information of the first user.

13. The method of claim 1, wherein identifying the object further comprises:
tracking a plurality of gazes of the first user;
detecting movement of the first user within the vehicle;
determining, in response to detecting the movement of the first user, a shared object that is common to the plurality of gazes; and
identifying the object based on the shared object.

14. A system comprising:
control circuitry configured to:
identify a movement of a first user of a vehicle;
identify an object referenced by the movement of the first user, wherein the object is external to the vehicle; and
determine that the object is at least partially obstructed from a field of view of a second user of the vehicle; and
input/output circuitry configured to:
in response to the control circuitry determining that the object is at least partially obstructed from a field of view of a second user of the vehicle, generate for display on a display within the vehicle that is within the field of view of the second user, a view of the object.

15. The system of claim 14, wherein the input/output circuitry is further configured to receive a first voice input from the first user, and wherein the control circuitry is further configured to identify the object referenced by the movement of the first user based on (a) the movement of the first user and (b) the first voice input.

16. The system of claim 14, wherein the control circuitry is further configured to identify the object external to the vehicle by detecting movement of the first user's head toward the object.

17. The system of claim 14, wherein the control circuitry is further configured to identify the object external to the vehicle by detecting movement of the first user's hand toward the object.

18. The system of claim 14, wherein the control circuitry is further configured to identify the object external to the vehicle by determining that the object external to the vehicle is included in a field of view of the first user.

19. The system of claim 14, wherein the control circuitry is further configured to identify the object referenced by the movement of the first user by
determining a field of view of the first user;
determining one or more potential objects within the field of view of the first user; and
selecting the object referenced by the movement of the first user from the one or more potential objects based on a voice input received from the first user.

20. The system of claim 14, wherein the control circuitry is further configured to determine that the object is at least partially obstructed from the field of view of the second user based on (a) a position of the second user inside the vehicle, (b) a field of view of the second user, and (c) vehicle structural information.

21-78. (canceled)
